(19) United States
(12) Patent Application Publication
(10) Pub. No.: US 2023/0065558 A1
(43) Pub. Date: Mar. 2, 2023

(54) METHOD FOR MODERATING A REACTION OF METAL PARTICLES

(71) Applicant: EOS GmbH Electro Optical Systems, Krailling (DE)

(72) Inventors: Ulrich Kleinhans, Prittriching (DE); Philip Stroebel, Weidenbach (DE); Sven Pawliczek, Gilching (DE); Florian Suelflow, Muenchen (DE); Fatime Imetovska, Rosenheim (DE); Tanja Kroener, Muenchen (DE)

(73) Assignee: EOS GmbH Electro Optical Systems, Krailling (DE)

(21) Appl. No.: 17/796,911

(22) PCT Filed: Jan. 25, 2021
(86) PCT No.: PCT/EP2021/051555

§ 371 Date: Aug. 2, 2022

(30) Foreign Application Priority Data
Feb. 3, 2020 (DE) 10 2020 102 628.5

(51) Int. Cl. B22F 1/12; B33Y 70/10

(52) U.S. Cl. CPC B22F 1/12; B33Y 70/10; B33Y 10/00

(57) ABSTRACT

Method for moderating a reaction of metal particles, in particular metal condensates, preferably from an additive manufacturing process, in particular a laser sintering or laser melting process, wherein the metal particles are combined, in particular mixed, with an at least partially meltable inerting material, wherein the inerting material comprises particles with a particle size of less than or equal to 100 µm.

The invention relates to a method for moderating a reaction of metal particles, in particular metal condensates, a use of a meltable inerting material, an additive manufacturing process, a manufacturing apparatus for additive manufacturing of objects, and a combination, in particular mixture, comprising metal particles.

In various applications, in particular in additive manufacturing processes, such as laser sintering or laser melting processes, metal particles (in particular metal condensates) are produced which can ignite due to corresponding chemical reactions (in particular oxidation) and represent a corresponding hazard.

In order to reduce the risk of corresponding overheating, in particular spontaneous ignition, it is already known to add lime powder (CaCO₃) to such metal particles. However, it has been shown that known methods for moderating the reaction of the metal particles still involve considerable risks.

It is therefore an object of the invention to propose a method for moderating a reaction, of metal particles, whereby an overheating, in particular spontaneous ignition, of the metal particles is to be prevented (or a corresponding risk is to be reduced) in as simple and yet safe a manner as possible. Furthermore, it is an object of the invention to propose a corresponding use of a meltable inerting material (passivating material), a corresponding additive manufacturing process, a corresponding manufacturing apparatus as well as a corresponding combination, comprising metal particles.

This object is solved in particular by the features of claim 1.

Preferably, the object is solved by a method for moderating a reaction of metal particles, in particular metal condensates, preferably from an additive manufacturing process, in particular a laser sintering or laser melting process, wherein the metal particles are combined, in particular mixed, with an at least partially meltable inerting material (passivating material). Particularly preferably, the inerting material (passivating material) comprises particles with a particle size less than or equal to 100 µm. Preferably, the particle size is less than or equal to 50 µm, further preferably less than or equal to 30 µm, possibly less than or equal to 20 µm, and/or greater than or equal to 0.1 µm, preferably greater than or equal to 1 µm. A preferred range would, for example, be a particle size (for at least 10% by weight, preferably at least 50% by weight of the particles) in the range of from 5 µm to 30 µm.

A first central idea of the invention is to propose an at least partially meltable inerting material or passivating material for moderating the reaction of the metal particles, wherein the inerting material preferably comprises particles having a comparatively small particle size (of in particular less than or equal to 100 µm). By melting the inerting material/ passivating material, a potential source of fire can be at least partially (possibly completely) covered and thus possibly extinguished. A particular advantage of melting also lies therein that a comparatively large amount of heat can be absorbed by this process (melting enthalpy). Due to a comparatively small particle size (grain size), it is possible for the inerting material to be comparatively cohesive. This improves the moderation of the reaction. Overall, a risk due to spontaneous ignition (of the metal particles in air or O₂-containing atmosphere) is thus reduced in a synergistic manner.

In particular, it was recognised according to the invention that lime powder (CaCO₃) thermally decomposes from (approx.) 800° C. and releases CO₂. This CO₂ can dissociate at comparatively high temperatures (from at least approx. 1500° C.) and fan the fire via carbon monoxide (CO) and possibly oxygen radicals. Especially when fresh or additional oxygen is added, flames can form (e.g. when metal particles are removed from a collecting or receiving device).

The particle size to be considered (independent of the material; this applies in particular to the metal particles) is preferably the diameter of a single particle or grain. If the particles form at least partial agglomerates (which should preferably be avoided as much as possible), the diameter of a single particle (grain) of the agglomerate should be considered. The diameter (particle size) of a single particle is preferably a respective maximum diameter (= supremum of all distances per two points of the particle) and/or a sieve diameter and/or an (especially volume-related) equivalent sphere diameter.

The individual particles of the inerting material/passivating material are preferably (at least approximately) of the same size (monodisperse). Alternatively, a particle size distribution may be present. If a particle size distribution is present, for example, a d50 particle size may be at least 2 times, preferably at least 4 times and/or at most 10 times, preferably at most 8 times as large as a d10 particle size. Alternatively or additionally, a d90 particle size may be at least 1.1 times, preferably 1.3 times and/or at most 3 times, preferably at most 1.7 times as large as a/the d50 particle size. The particle sizes may be determined by sieving, if necessary. Alternatively or additionally, the particle sizes may be determined by laser diffraction methods (in particular by means of laser diffraction measurement according to ISO 13320 or ASTM B822). Alternatively or additionally, the particle sizes can be determined by measuring (for example by means of a microscope) and/or with dynamic image analysis (preferably according to ISO 13322-2, possibly by means of the CAMSIZER® XT of Retsch Technology GmbH). If the particle size is determined from a 2-dimensional image (e.g. of a microscope, in particular an electron microscope), the respective diameter (maximum diameter or equivalent diameter) resulting from the 2-dimensional image is preferably used.

A diameter perpendicular to the maximum diameter (= supremum of all distances between two points of the particle whose connecting line is perpendicular to the maximum diameter) is preferably at least 0.1 times, further preferably at least 0.5 times, further preferably at least 0.7 times and/or at most 1.0 times, preferably 0.9 times as large as the maximum diameter (either in the 3-dimensional or, in particular when determining the respective diameter from an image, in the 2-dimensional, with respect to the imaging plane).

The metal particles may be (at least proportionally, optionally all) round or spherical and (in the case of non-uniform particles)/or (at least proportionally, optionally all) angular (e.g. produced or at least producible by grinding), optionally cuboidal.

Preferably, the metal particles comprise at least partially, optionally in atomic % predominantly: at least one metal, preferably at least one catalytically active metal (such as: Ni, Co, Fe, Rh, Ru, Pt, Pd and/or Zr) and/or at least one electrochemically active metal and/or at least one pyrophoric metal (such as: Mg, Ti, Ni, Co, Fe, Pb, at least one lanthanide and/or at least one actinide), particularly preferred Al, Fe, Ti, Ni, Co, Pt, Ag, Pd, Sc, Au, Zn, Zr, Mg, V, Si, Cu, Mn, W, Nb and/or Cr. Furthermore, partially, possibly in atomic % predominantly, may be provided: Mo, C and/or O. The respective element may preferably be present in at least 5 atom%, further preferably at least 20 atom%, optionally at least 50 atom% or even at least 90 atom%.

In the additive manufacturing process, in particular the laser sintering or laser melting process, preferably a manufacturing apparatus is used which is configured to manufacture an object by applying a build-up material, which comprises at least substantially metallic and/or ceramic components, layer upon layer and selectively solidifying the build-up material, in particular by means of supplying radiation energy, at locations in each layer which are associated with the cross-section of the object in that layer. Particularly preferably, at least one laser is used here or a laser sintering process is carried out.

The metal particles can preferably have a (possibly average) particle size of at least 1 nm, preferably at least 3 nm, still further preferably at least 4 nm and/or at most 1000 nm, preferably at most 100 nm, possibly at most 50 nm. In this context, the particle size is preferably defined or can be determined as described further above in connection with the particle size of the particles of the inerting material. The individual particles may be (at least substantially or at least approximately) equal in size, or there may be a particle size distribution. If a particle size distribution is present, a d10 particle size may be at least 0.1 times, preferably at least 0.2 times and/or at most 1.0 times, preferably at most 0.9 times as large as a d50 particle size. Alternatively or additionally, a d90 particle size may be at least 1.0 times, preferably at least 1.2 times, further preferably at least 1.4 times and/or at most 10 times, preferably at most 5 times, further at most 4 times as large as a d50 particle size.

The metal particles are preferably at least approximately round.

The metal particles may be (at least proportionally, optionally all) round or spherical and (in the case of non-uniform particles)/or (at least proportionally, optionally all) angular (e.g. produced or at least producible by grinding), possibly cuboidal.

A diameter perpendicular to the maximum diameter (= supremum of all distances between two points of the particle whose connecting line is perpendicular to the maximum diameter) is preferably at least 0.1 times, further preferably at least 0.5 times, further preferably at least 0.7 times and/or at most 1.0 times, preferably at most 0.9 times as large as the maximum diameter (either in the 3-dimensional or, in particular when determining the respective diameters from an image, in the 2-dimensional with respect to the image plane).

Preferably, the metal particles have a specific surface area of at least 0.01 m²/g, preferably at least 1 m²/g, further preferably at least 5 m²/g, still further preferably at least 10 m²/g and/or at most 1000 m²/g, preferably at most 500 m²/g, further preferably at most 200 m²/g, still further preferably at most 50 m²/g. The specific surface area can be determined (in particular in the case of non-porous particles) by measuring at least 100, preferably at least 1,000 randomly selected (for example, recognisable and juxtaposed on a SEM image) particles so that their surface area and (knowing the material density) their weight can be calculated. If necessary, a BET measurement can also be carried out, preferably according to DIN ISO 9277 (valid in the Federal Republic of Germany at the time of application) A gas adsorption during the measurement (e.g. for N₂) can depend on the relative pressure P/P₀. The amount of adsorbed gas can be determined statically-volumetrically (isotherm). A sample quantity can be 100 mg. The “Quantachrome Nova® 4200e” analyser can be used for the measurement.

By an at least partially meltable inerting material (passivating material) shall preferably be understood a material that can melt as such (i.e. without prior chemical conversion). Materials in which only a residual product can melt (for example after thermal decomposition of the starting product) shall in particular not be understood as partially meltable inerting material. In particular, the partially meltable inerting material (as such) shall transform into the liquid phase (before it chemically transforms, for example thermally decomposes) when a certain temperature (at a pressure of 1 bar) is exceeded. Preferably the inerting material (for example in the case of a mixture) shall be able to melt (at least approximately) completely (when exceeding a predetermined temperature and a pressure of one bar to at least 10% by weight, preferably at least 25% by weight, further preferably at least 50% by weight, still further preferably at least 80% by weight.

By an inerting material or passivating material is preferably to be understood a material which moderates the reaction of metal particles, in particular in the sense that reaction heat can be absorbed and thus the reaction be slowed down.

Moderation of the reaction may comprise: An absorption of heat by the inerting material (moderation material), in particular by heating the same, and/or a (heat absorbing) phase transformation (e.g. melting) of the inerting material (moderation material) and/or a thermal (endothermic) decomposition or transformation of the inerting material (moderation material), e.g. as in the case of lime (CaCO₃ -> CaO + CO₂).

Alternatively or additionally, the moderation of the reaction may comprise: A spatial separation of the metal particles by the inerting material (moderation material) (so that metal no longer lies against or on metal and thereby preferably resulting in a slowed heat conduction), e.g. by forming an envelope (protective shell) of inerting material (e.g.: potassium glass).

Alternatively or additionally, the moderation of the reaction may comprise (or just not comprise, or at least not only comprise): reduction of the reactivity by the inerting material, preferably by an especially chemical interaction, preferably chemical reaction, of the metal particles with the inerting material (possibly the inerting material present e.g. as KMnO₄ can possibly release O₂). It would be conceivable that, for example, oxygen molecules attached to the surface (by absorption and/or adsorption) of the inerting material (e.g. glass powder) react with the condensate and thus reduce the reactivity. This can be promoted, if necessary, when the inerting material becomes very fine (particle size <10 µm) and thus has a relatively high surface area and/or (also as an optionally independently further forming idea, without the preceding features of this paragraph) if the inerting material is mesoporous (average pore size between 2 and 50 nm) or microporous (average pore size smaller than 2 nm). This allows, for example, O₂ to be brought to the metal particles from inside (in pores) of the inerting material.

A specific thermal conductivity of the inerting material (at 25° C.) may be at least 0.4 W/(m*K), optionally at least 0.6 W/(m*K) and/or at most 2.0 W/(m*K) or at most 1.2 W/(m*K).

A specific heat capacity of the inerting material (at 25° C.) may be at least 0.5 kJ/(kg*K), optionally at least 0.7 kJ/(kg*K) or at least 0.8 kJ/(kg*K), and/or at most 3.0 kJ/(kg*K) or at most 2.0 kJ/(kg*K).

The inerting material may contain oxygen (chemically bound, surface attached and/or internally trapped, e.g. adsorbed).

The inerting material may comprise expanded material, in particular expanded glass, and/or hollow bodies, in particular hollow spheres.

Preferably, the inerting material (passivating material) comprises at least 10% by weight, more preferably at least 50% by weight of particles having a particle size of less than or equal to 100 µm, preferably less than or equal to 50 µm, more preferably less than or equal to 30 µm, optionally less than or equal to 20 µm, and/or greater than or equal to 0.1 µm, preferably greater than or equal to 1 µm. For example, a preferred range would be a particle size (for at least 10% by weight, preferably at least 50% by weight of the particles) in the range of 5 µm to 30 µm.

Preferably, the inerting material is comparatively cohesive or flour-like.

In embodiments, the inerting material comprises glass, in particular glass particles, and/or at least one, preferably low-melting and/or hygroscopic (alternatively: non-hygroscopic), salt, in particular (corresponding) salt particles. The salt may be present in pure form or as a mixture of different (per se pure) salts. In this respect, “salt” without further specification is to be understood as a generic term for pure salt (e.g. NaCl) or a salt mixture. A hygroscopic salt is to be understood in particular as a salt which attracts (i.e. absorbs) water at a normal pressure of 1.0 bar and a relative humidity of the environment of 50%. A non-hygroscopic salt shall be understood to be in particular a salt which does not attract (i.e. does not absorb) water at a normal pressure of 1.0 bar and a relative humidity of the environment of 50%. Where appropriate, the salt, in particular the salt particles, may comprise NaCl, saccharose, SiO₂ (silica gel), sodium hydroxide, potassium hydroxide, a nitrate, salicylate, and/or calcium chlorite. Any of said salts and/or any combination of said salts may be present in at least 10% by weight in the inerting material. In particular, the salt may be formed by a salt mixture with a low melting point (eutectic point) (for example, by a mixture of LiCl (e.g. 56 mol%) and KCl (e.g. 44 mol%), which may melt, for example, as low as 355° C.).

The inerting material may alternatively or additionally comprise at least one mineral, e.g. kaolin and/or dolomite and/or (mineral-containing) fly ash, preferably coal fly ash.

The inerting material may alternatively or additionally comprise iron III oxide (Fe₂O₃).

The inerting material may alternatively or additionally comprise quicklime (CaO) and/or water glass (CaOH). The inerting material preferably comprises less than 10% by weight of lime (CaCO₃), further preferably less than 5% by weight of lime, still further preferably less than 1% by weight of lime. In particular, the inerting material is (at least substantially) lime-free.

A low melting point (e.g. a low melting salt or salt mixture) is generally preferred. At least one meltable component of the inerting material may have a melting temperature (at normal pressure of 1.0 bar) of at most 1200° C., preferably at most 800° C., further preferably at most 600° C., possibly at most 450° C. or at most 300° C. A comparatively low melting temperature has in particular the advantage that the metal particles can effectively be enveloped by the inerting material (at corresponding temperature increase), so that safety is improved. As far as reference is made here and in the following to a melting temperature, this can be understood to be a temperature at which (or from which) at least parts of the inerting material transform into the liquid state. Where appropriate, a state of the inerting material can be understood here (or further above and below, as far as a melting temperature is concerned) at which at least parts of it (possibly at least 10% by weight) have a viscosity of less than or equal to 200 Pa s, in particular less than or equal to 25 Pa s (at 1.0 bar ambient pressure). Any of the upper temperature limits given in this paragraph may be combined with any other upper temperature limit to form a range according to the invention whose lower temperature limit is the smaller of the two respective upper temperature limits.

At least one meltable component of the inerting material may have a melting temperature, at normal pressure of 1.0 bar, of at least 100° C., preferably at least 300° C., possibly at least 500° C. or at least 800° C. By that it can possibly be prevented that the particles of the inerting material melt during employment and that the inerting material permanently bonds with the metal particles during resolidification. This can be advantageous with regard to disposal and/or recycling aspects. The lower temperature limits given in this paragraph may each be combined with any of the upper temperature limits given in the preceding paragraph to form a corresponding range according to the invention insofar as this is not logically excluded. Any of the lower temperature limits given in this paragraph may be combined with any other lower temperature limit to form a range according to the invention whose upper temperature limit is the greater of the two respective lower temperature limits.

As glass, in particular glass particles, preferably (at least proportionally, in particular to at least 10% by weight) soda glass, particularly preferably soda-lime glass, and/or borosilicate glass and/or expanded glass (expanded glass granulate) is employed.

The above-mentioned object is further solved by the use of a meltable inerting material or passivating material for moderating a reaction of metal particles, in particular metal condensates, from an additive manufacturing process, in particular a laser sintering or laser melting process, wherein the inerting material comprises particles with a particle size of less than or equal to 100 µm.

In particular, a material shall be said to be meltable if it can be converted into the liquid state (by heating) and/or at least into a state in which the viscosity is less than or equal to 200 Pa s, preferably less than or equal to 25 Pa s (at 1.0 bar ambient pressure).

The above object is further solved by an additive manufacturing process, in particular laser sintering or laser melting process, comprising the above method for moderating a reaction of metal particles, in particular metal condensates.

The above object is further solved by a manufacturing apparatus for additive manufacturing of objects, preferably according to the above additive manufacturing process, in particular by a laser sintering or laser melting device, comprising a meltable inerting material/passivating material for moderating a reaction of metal particles, in particular metal condensates, from a corresponding additive manufacturing process, in particular a laser sintering or laser melting process, wherein the inerting material comprises particles having a particle size of less than or equal to 100 µm. According to this aspect of the invention, the manufacturing apparatus shall thus already comprise the passivating material (inerting material) according to the invention, for example in a container and/or a feeding device, so that it can be fed to corresponding metal condensates (during the additive manufacturing process).

The manufacturing apparatus is preferably configured to perform the above method for moderating a reaction of metal particles and/or to enable the above use of a meltable inerting material.

The above Object is further solved by a combination, in particular a mixture, comprising metal particles, in particular metal condensate, from an additive manufacturing process, in particular the above additive manufacturing process, in particular a laser sintering or laser melting process, and a meltable inerting material (passivating material), wherein the inerting material comprises particles having a particle size less than or equal to 100 µm. In particular, the combination is configured to perform the above method for moderating a reaction of metal particles and/or to enable the above use of a meltable inerting material.

When metal particles and inerting material are combined, in particular mixed, or are present as combination, in particular mixture, a proportion by weight of the inerting material within the combination (the mixture) shall preferably be at least 2% by weight, further preferably at least 5% by weight, still further preferably at least 10% by weight, still further preferably at least 30% by weight and/or at most 95% by weight, preferably at most 80% by weight.

The combination, in particular the mixture, may be present in or (procedurally) be placed into a container.

The inerting material may comprise an oxidizer. However, possibly, the inerting material comprises less than 50% by weight, more preferably less than 25% by weight, further preferably less than 5% by weight, possibly less than 1% by weight or 0.1% by weight, of a material which (such as lime powder) is a source of oxidant.

The inerting material (passivating material) can be used in a filter system, in particular recirculating air filter system of a manufacturing apparatus for additive manufacturing of objects, in particular a laser sintering or laser melting plant, and/or for material originating from such a filter system.

Further embodiments of the invention will be apparent from the dependent claims.

In the following, the invention will be described with reference to examples of embodiments, which will be explained in more detail with reference to the figures.

Hereby show:

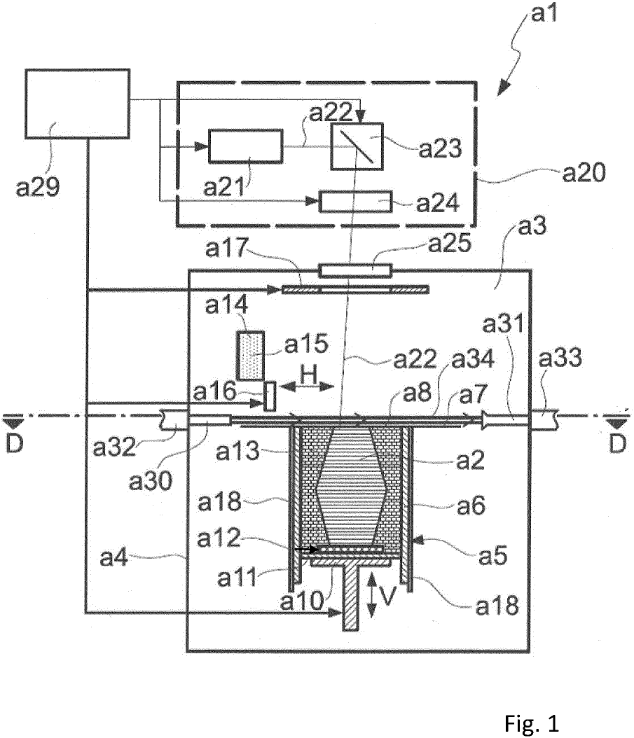

FIG. 1 a schematic illustration, partially reproduced as a cross-section, of a device for the layer-by-layer build-up of a 3-dimensional object;

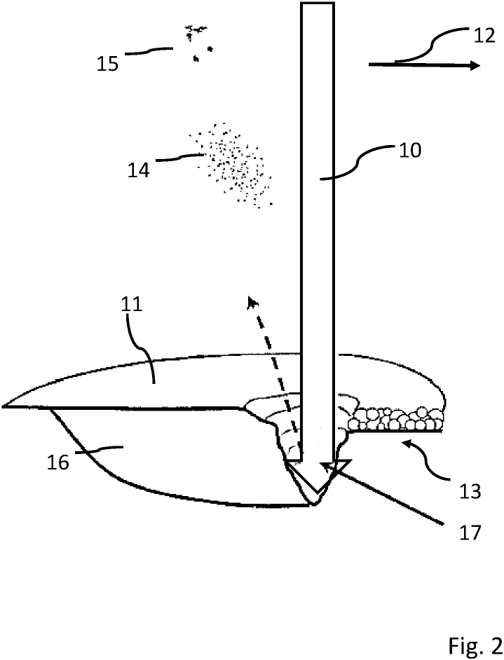

FIG. 2 a schematic representation of a formation of metal particles;

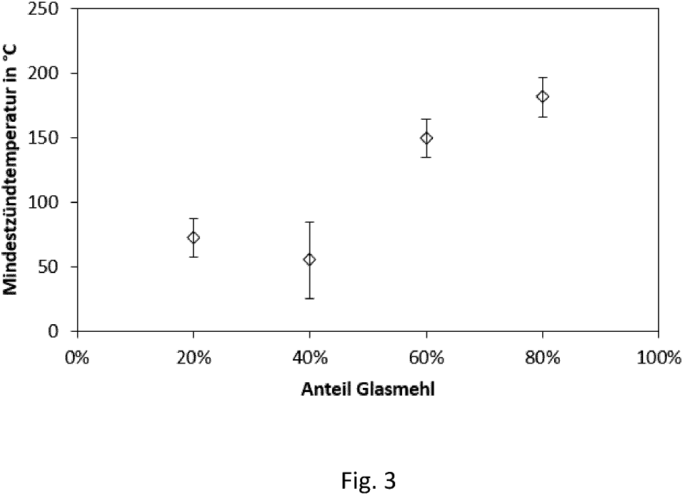

FIG. 3 a diagram of a minimum ignition temperature in °C as well as a proportion of an inerting material in % by weight; and

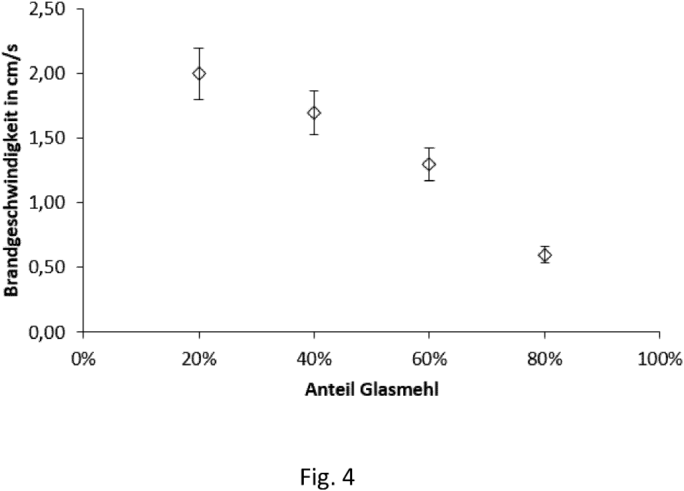

FIG. 4 a diagram of a burning rate in cm/s as well as a proportion of inerting material in % by weight.

In the following description, the same reference numerals are used for the same and same-acting parts.

The device shown in FIG. 1 is a laser sintering or laser melting device a1 known per se. For building-up an object a2 it contains a process chamber a3 with a chamber wall a4. In the process chamber a3, an upwardly open build-up container a5 with a wall a6 is arranged. A working plane a7 is defined by the upper opening of the build-up container a5, wherein the area of the working plane a7 lying within the opening, which can be used to build the object a2, is referred to as the build-up area a8. In the container a5 a support a10, which is movable in a vertical direction V, is arranged, to which a base plate a11 is attached, which closes off the build-up container a5 at the bottom and thus forms its base. The base plate a11 can be a plate formed separately from the support a10 and attached to the support a10, or it can be formed integrally with the support a10. Depending on the powder and process used, on the base plate a11 there may also be attached a building platform a12 on which the object a2 is built. However, the object a2 can also be built on the base plate a11 itself, which then serves as the building platform. In FIG. 1, the object a2 to be formed in the build-up container a5 on the building platform a12 is shown below the working plane a7 in an intermediate state with several solidified layers surrounded by build-up material a13 that has remained unsolidified. The laser sintering device a1 further comprises a storage container a14 for a owedered build-up material a15 solidifiable by electromagnetic radiation and a coater a16 movable in a horizontal direction H for applying the build-up material a15 to the build-up area a8. The laser sintering device a1 further comprises an exposure device a20 having a laser a21 which generates a laser beam a22 as an energy beam bundle which is deflected via a deflection device a23 and focused onto the working plane a7 by a focusing device a24 via a coupling window a25 which is provided on the upper side of the process chamber a3 in the wall a4 thereof.

Further, the laser sintering device a1 includes a control unit a29 via which the individual components of the device a1 are controlled in a coordinated manner to perform the build-up process. The control unit a29 may include a CPU whose operation is controlled by a computer program (software). The computer program may be stored separately from the device on a storage medium from which it can be loaded into the device, in particular into the control unit. In operation, to apply a powder coating, the support a10 is first lowered by a height corresponding to the desired layer thickness.

By moving the coater a16 over the working plane a7, a layer of the pulverulent build-up material a15 is then applied. For safety, the coater a16 pushes a slightly larger amount of build-up material a15 in front of it than is required to build up the layer. The coater a16 pushes the scheduled excess of build-up material a15 into an overflow container a18.

On each side of the build-up container a5 an overflow container a18 is arranged. The application of the powdered build-up material a15 takes place at least over the entire cross section of the object a2 to be produced, preferably over the entire build-up area a8, i.e., the area of the working plane a7 that can be lowered by a vertical movement of the support a10. Subsequently, the cross-section of the object a2 to be manufactured is scanned by the laser beam a22 with a radiation impact area (not shown), which schematically represents an intersection of the energy beam with the working plane a7. As a result, the powdered build-up material a15 is solidified at locations corresponding to the cross-section of the object a2 to be manufactured. These steps are repeated until the object a2 is completed and can be removed from the build-up container a5.

For generating a preferably laminar process gas flow a34 in the process chamber a3, the laser sintering device a1 further comprises a gas supply channel a32, a gas inlet nozzle a30, a gas outlet opening a31 and a gas discharge channel a33. The process gas flow a34 moves horizontally across the build-up area a8. The gas supply and discharge may also be controlled by the control unit a29 (not shown). The gas exhausted from the process chamber a3 may be fed to a filtering device (not shown), and the filtered gas may be fed back to the process chamber a3 via the gas supply channel a32, forming a recirculation system with a closed gas loop. Instead of only one gas inlet nozzle a30 and one gas outlet opening a31, several nozzles or openings can be provided in each case.

In this case, condensed metal particles can now be present on and/or removed from, for example, the wall a4 or the (not shown) filter device. This material should then preferably be moderated according to the invention.

In FIG. 2 it is schematically illustrated how the metal particles are presumably created according to the embodiment. A laser beam 10 is hereby moved over a surface 11. A corresponding direction of movement is symbolised by the arrow 12. The laser beam 10 melts starting material 13, whereby a part of the starting material is vaporised. The molten starting material is marked with the reference sign 16, the gaseous starting material with the reference sign 17. A so-called vapour capillary is formed at the point where the laser beam impinges. This contains vaporised material (e.g. metal) at high temperatures as plasma. It is ejected from the vapour capillary (keyhole) at high speeds due to buoyancy effects and material flowing up from below or subsequently vaporised. By cooling of the metal vapour a supersaturation of the gas phase and thus a condensation (homogeneous condensation) is caused. From this condensation metal particles 14 are formed. This can still form agglomerates 15 in the further course of time.

In FIGS. 3 and 4 the effect of an inerting material (here: glass powder) on a minimum ignition temperature and a burning rate in the case of an iron condensate (starting point is the high-alloy forged steel MS1) is explained.

According to FIG. 3, the addition of glass powder can significantly raise a minimum ignition temperature at which spontaneous ignition takes place. In comparison, lime powder showed significantly lower minimum ignition temperatures at high proportions.

Particularly good results could be achieved with a comparatively fine grain size (particle size), especially so that the inerting material is comparatively cohesive.

According to FIG. 4, a burning rate could be progressively reduced by adding glass powder. Here, too, it was found that a comparatively fine particle size (grain size), so that the inerting material is cohesive and can be mixed well with the metal condensate, is advantageous.

At this point, it should be noted that all the parts described above, considered alone and in any combination, in particular the details shown in the drawings, are claimed to be essential to the invention. Modifications thereof are familiar to the skilled person.

### LIST OF REFERENCE SIGNS

a1 laser sintering or laser melting device
a2 object
a3 process chamber
a4 chamber wall
a5 build-up container
a6 wall
a7 working plane
a8 build-up area
a10 movable support
a11 base plate
a12 building platform
a13 unsolidified build-up material
a14 storage container
a15 powdered build-up material / aluminium alloy
a16 movable coater
a20 exposure device
a21 laser
a22 laser beam
a23 deflection device
a24 focusing device
a25 coupling window
a29 control unit
a30 gas inlet nozzle
a31 gas outlet opening
a32 gas supply channel
a33 gas discharge channel
a34 laminar process gas flow
H horizontal direction
V vertical direction
10 laser beam
11 surface
12 arrow
13 starting material
14 metal particle
15 agglomerate (of metal particles)
16 molten starting material
17 vaporised starting material

1. Method for moderating a reaction of metal particles from an additive manufacturing process, wherein the metal particles are combined with an at least partially meltable inerting material, wherein the inerting material comprises particles with a particle size of less than or equal to 100 µm.

2. Method according to claim 1,
wherein the inerting material comprises at least 10% by weight, of particles having a particle size of less than or equal to 100 µm and/or greater than or equal to 0.1 µm.

3. Method according to claim 1 ,
wherein the inerting material comprises glass and/or at least one salt.

4. Method according to claim 1,
wherein the inerting material comprises less than 10% by weight of lime .

5. Method according to claim 1,
wherein at least one meltable component of the inerting material has a melting temperature, at normal pressure of 1.0 bar, of at most 1200° C. .

6. Method according to claim 1,
wherein at least one meltable component of the inerting material has a melting temperature, at normal pressure of 1.0 bar, of at least 100° C. .

7. A method comprising:
moderating a reaction of metal particles from an additive manufacturing process with a meltable inerting material, wherein the inerting material comprises particles with a particle size of less than or equal to 100 µm.

8. Additive manufacturing process comprising the method of moderating a reaction of metal particles according to claim 1.

9. Manufacturing apparatus– for additive manufacturing of objects comprising a meltable inerting material for moderating a reaction of metal particles according to the manufacturing process according to claim 8, wherein the inerting material comprises particles having a particle size smaller than or equal to 100 µm.

10. Combination comprising metal particles from an additive manufacturing process according to claim 8, and an at least partially meltable inerting material, wherein the inerting material comprises particles having a particle size smaller than or equal to 100 µm.
